(19) United States
(12) Patent Application Publication
(10) Pub. No.: US 2012/0069075 A1
(43) Pub. Date: Mar. 22, 2012

(54) OPTICAL SENSOR FOR PRINTER MEDIA MOTION DETECTION

(76) Inventors: Thomas D. Pawlik, Rochester, NY (US); Mark C. Rzadca, Fairport, NY (US); Thomas F. Powers, Webster, NY (US)

(21) Appl. No.: 12/887,532

(22) Filed: Sep. 22, 2010

(51) Int. Cl. B41J 29/38

(52) U.S. Cl. 347/16

(57) ABSTRACT

An inkjet printer includes a paper tray for holding print media; a pick-up roller for moving the print media along at least a portion of a pre-print zone of a paper transport path; a light source disposed along the pre-print zone of the paper transport path that directs light toward a non-print side of the print media for illuminating the non-print side of the print media; and an array sensor that receives reflected light from the non-print side of the print media; wherein data from the sensor is used to determine an amount of motion of the print media in the pre-print zone.

### CROSS REFERENCE TO RELATED APPLICATIONS

Reference is made to commonly assigned U.S. patent application Ser. No. 12/871,068 filed Aug. 30, 2010 by Rzadca et al., entitled “Encoder for Inkjet Printers”, the disclosure of which is herein incorporated by reference.

### FIELD OF THE INVENTION

The present invention generally relates to encoders for inkjet printers. More specifically, the present invention relates to using an optical encoder for sensing the motion of the print media.

### BACKGROUND OF THE INVENTION

An inkjet printing system typically includes one or more printheads and their corresponding ink supplies. Each printhead includes an ink inlet that is connected to its ink supply and an array of drop ejectors, each ejector consisting of an ink pressurization chamber, an ejecting actuator and a nozzle through which droplets of ink are ejected. The ejecting actuator may be one of various types, including a heater that vaporizes some of the ink in the pressurization chamber in order to propel a droplet out of the orifice, or a piezoelectric device which changes the wall geometry of the chamber in order to generate a pressure wave that ejects a droplet. The droplets are typically directed toward paper or other recording medium in order to produce an image according to image data that is converted into electronic firing pulses for the drop ejectors as the recording medium is moved relative to the printhead.

A common type of printer architecture is the carriage printer, where the printhead nozzle array is somewhat smaller than the extent of the region of interest for printing on the recording medium and the printhead is mounted on a carriage. In a carriage printer, the recording medium is advanced a given distance along a media advance direction and then stopped. While the recording medium is stopped, the printhead carriage is moved in a direction that is substantially perpendicular to the media advance direction as the drops are ejected from the nozzles. After the carriage has printed a swath of the image while traversing the recording medium, the recording medium is advanced; the carriage direction of motion is reversed, and the image is formed swath by swath.

The ink supply on a carriage printer can be mounted on the carriage or off the carriage. For the case of ink supplies being mounted on the carriage, the ink tank can be permanently integrated with the printhead as a print cartridge, so that the printhead needs to be replaced when the ink is depleted, or the ink tank can be detachably mounted to the printhead so that only the ink tank itself needs to be replaced when the ink tank is depleted. Carriage mounted ink supplies typically contain only enough ink for up to about several hundred prints. This is because the total mass of the carriage needs to be limited so that accelerations of the carriage at each end of the travel do not result in large forces that can shake the printer back and forth.

Pickup rollers are used to advance the print media from its holding tray along a transport path towards a print zone beneath the carriage printer where the ink is projected onto the print media. The pickup roller is part of a complex gear train in which the pickup roller initiates print movement and a drive system encoder is disposed on the gear train (or coaxially of the pickup roller) for reading the amount of motion. It is instructive to note that, in the prior art, the encoder does not directly monitor the print media. Furthermore, lacking a means of directly sensing movement of the media, any slippage of the media with respect to the drive system is not apparent via the encoder of the prior art. Some printers include a barcode reader adjacent to the pickup roller for reading a barcode, described below, on the print media as it passes beneath the barcode reader.

In regards to the barcode, the print media may include barcodes on its non-printing side for identifying the type of print media so that printing adjustments can be made depending on the type of print media. The barcode includes a plurality of parallel lines in a predetermined spaced-apart relationship. The width of the spacing varies according to the type of print media so that each type of print media has its own unique barcode. Any slippage of the print media as it is being read by the barcode reader can cause the type of print media to be misidentified.

Although the presently used system is satisfactory, improvements are always desirable. One such improvement is improved accuracy of reading the print media motion so that accurate readings of the barcode are obtained.

### SUMMARY OF THE INVENTION

The present invention is directed to overcoming one or more of the problems set forth above. Briefly summarized, according to one aspect of the invention, the invention resides in an inkjet printer comprising (a) a paper tray for holding print media; (b) a pick-up roller for moving the print media along at least a portion of a pre-print zone of a paper transport path; (c) a light source disposed along the pre-print zone of the paper transport path that directs light toward a non-print side of the print media for illuminating the non-print side of the print media; and (d) an array sensor that receives reflected light from the non-print side of the print media; wherein data from the sensor is used to determine an amount of motion of the print media in the pre-print zone.

These and other objects, features, and advantages of the present invention will become apparent to those skilled in the art upon a reading of the following detailed description when taken in conjunction with the drawings wherein there is shown and described an illustrative embodiment of the invention.

### ADVANTAGEOUS EFFECT OF THE INVENTION

The present invention has the advantage of providing accurate measurement of the motion of the print media for enabling accurate reading of the media markings, such as bar codes, on the print media. A first source of unreliability in the identification of media markings is media slip during advance of the media. In typical carriage printers, a rotary encoder is provided in association with one of the media advance rollers, such as the feed roller. The amount of rotation of the encoder (and its associated roller) is monitored and is related to the nominal distance of media advance by Rθ, where R is the radius of the associated roller plus the media thickness. However, this nominal distance of media advance will be in error if the media slips relative to the roller during media advance, and/or if the wrong thickness of media is assumed. A second source of unreliability in the identification of the media markings is media skew; in particular, if the media markings are not oriented perpendicular to the media advance direction. The distance between media markings as detected by the barcode sensor will depend upon the orientation of the media markings relative to the media advance direction. Direct sensing provides greater accuracy (compared with the prior art drive system encoder) in terms of delivering the leading edge to a predetermined position. In addition, a direct sensing encoder, in combination with the prior art drive system encoder, provides an ability to quickly detect when a paper miss-feed has occurred. If the paper should stall after motion begins, or if motion does not begin when anticipated, the lack of motion can be quickly discerned by the lack of motion signal from the optical sensor.

### BRIEF DESCRIPTION OF THE DRAWINGS

The above and other objects, features, and advantages of the present invention will become more apparent when taken in conjunction with the following description and drawings wherein identical reference numerals have been used, where possible, to designate identical features that are common to the figures, and wherein:

While the specification concludes with claims particularly pointing out and distinctly claiming the subject matter of the present invention, it is believed that the invention will be better understood from the following description when taken in conjunction with the accompanying drawings, wherein:

FIG. 1 is a schematic representation of an inkjet printer system;

FIG. 2 is a perspective view of a portion of a printhead;

FIG. 3 is a perspective view of a portion of a carriage printer;

FIG. 4 is a schematic side view of a paper path in a carriage printer of the present invention;

FIG. 5 is a schematic representation of comparative performance of the present invention and the prior art in the presence of media slip;

FIG. 6 is an embodiment of the optical media motion encoder of the present invention;

FIG. 7b is data representing a one dimensional brightness profile of the scene consisting of the linear barcode shown in FIG. 7a; and

FIG. 7a illustrates a barcode used for the data in FIG. 7b.

### DETAILED DESCRIPTION OF THE INVENTION

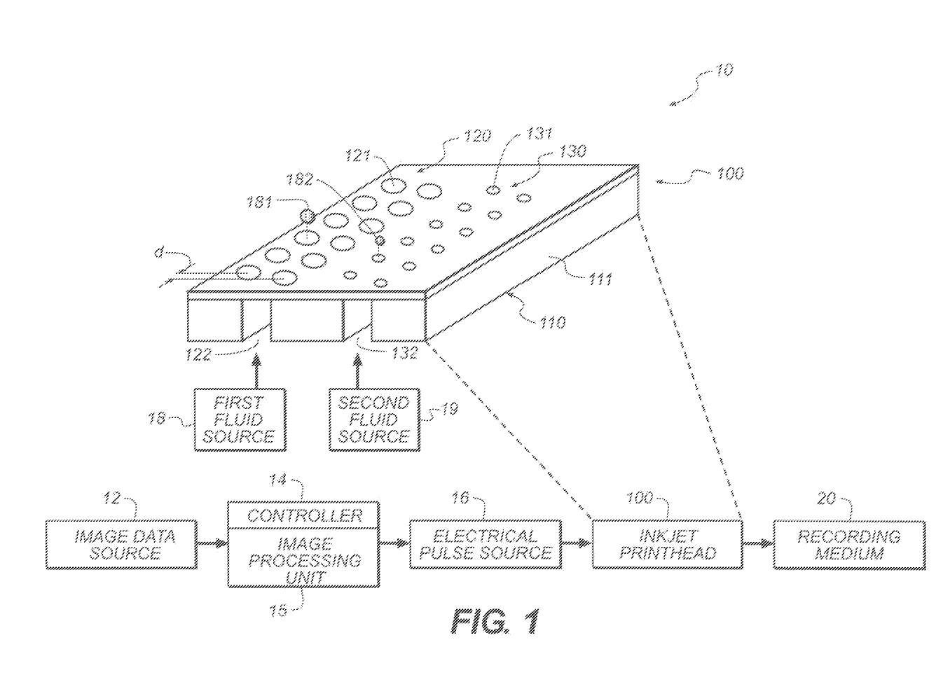

Referring to FIG. 1, a schematic representation of an inkjet printer system 10 is shown for its usefulness with the present invention and is fully described in U.S. Pat. No. 7,350,902, which is incorporated by reference herein in its entirety. Inkjet printer system 10 includes an image data source 12, which provides data signals that are interpreted by a controller 14 as being commands to eject drops. Controller 14 includes an image processing unit 15 for rendering images for printing, and the controller 14 outputs signals to an electrical pulse source 16 of electrical energy pulses that are inputted to an inkjet printhead 100, which includes at least one inkjet printhead die 110.

In the example shown in FIG. 1, there are two nozzle arrays. Nozzles 121 in the first nozzle array 120 have a larger opening area than nozzles 131 in the second nozzle array 130. In this example, each of the two nozzle arrays has two staggered rows of nozzles, each row having a nozzle density of 600 per inch. The effective nozzle density then in each array is 1200 per inch (i.e. d= 1/1200 inch in FIG. 1). If pixels on the recording medium 20 were sequentially numbered along the paper advance direction, the nozzles from one row of an array would print the odd numbered pixels, and the nozzles from the other row of the array would print the even numbered pixels.

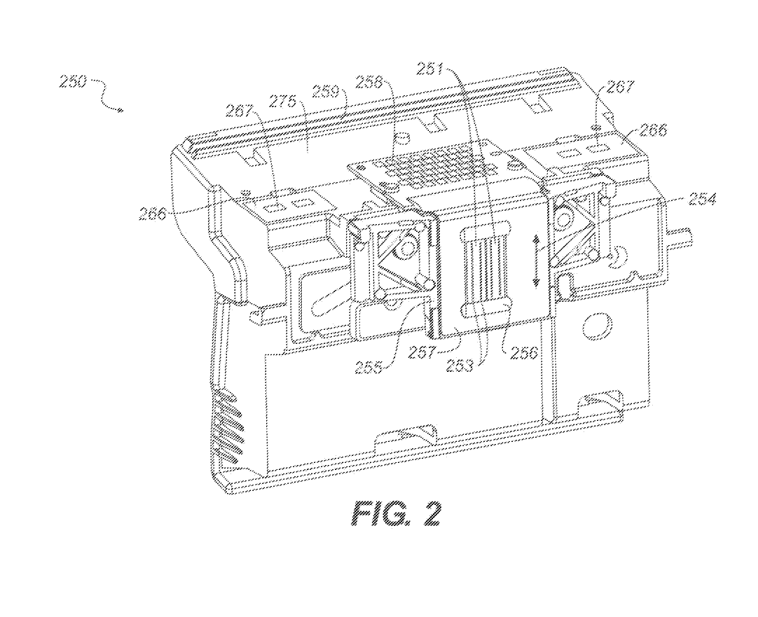

In fluid communication with each nozzle array is a corresponding ink delivery pathway. Ink delivery pathway 122 is in fluid communication with the first nozzle array 120, and ink delivery pathway 132 is in fluid communication with the second nozzle array 130. Portions of ink delivery pathways 122 and 132 are shown in FIG. 1 as openings through printhead die substrate 111. One or more inkjet printhead die 110 will be included in inkjet printhead 100, but for greater clarity only one inkjet printhead die 110 is shown in FIG. 1. The printhead die are arranged on a support member as discussed below relative to FIG. 2. In FIG. 1, first ink source 18 supplies ink to first nozzle array 120 via ink delivery pathway 122, and second ink source 19 supplies ink to second nozzle array 130 via ink delivery pathway 132. Although distinct ink sources 18 and 19 are shown, in some applications it may be beneficial to have a single ink source supplying ink to both the first nozzle array 120 and the second nozzle array 130 via ink delivery pathways 122 and 132 respectively. Also, in some embodiments, fewer than two or more than two nozzle arrays can be included on printhead die 110. In some embodiments, all nozzles on inkjet printhead die 110 can be the same size, rather than having multiple sized nozzles on inkjet printhead die 110.

The drop forming mechanisms associated with the nozzles are not shown in FIG. 1. Drop forming mechanisms can be of a variety of types, some of which include a heating element to vaporize a portion of ink and thereby cause ejection of a droplet, or a piezoelectric transducer to constrict the volume of a fluid chamber and thereby cause ejection, or an actuator which is made to move (for example, by heating a bi-layer element) and thereby cause ejection. In any case, electrical pulses from electrical pulse source 16 are sent to the various drop ejectors according to the desired deposition pattern. In the example of FIG. 1, droplets 181 ejected from the first nozzle array 120 are larger than droplets 182 ejected from the second nozzle array 130, due to the larger nozzle opening area. Typically other aspects of the drop forming mechanisms (not shown) associated respectively with nozzle arrays 120 and 130 are also sized differently in order to optimize the drop ejection process for the different sized drops. During operation, droplets of ink are deposited on a recording medium 20.

FIG. 2 shows a perspective view of a portion of a print cartridge 250, which is an example of an inkjet printhead 100 plus ink sources 18 and 19. Print cartridge 250 includes two printhead die 251 (similar to printhead die 110 in FIG. 1) that are affixed to mounting substrate 255. Each printhead die 251 contains two nozzle arrays 253 so that print cartridge 250 contains four nozzle arrays 253 altogether. The four nozzle arrays 253 in this example are each connected to ink sources (not shown in FIG. 2), such as cyan, magenta, yellow, and black. Each of the four nozzle arrays 253 is disposed along nozzle array direction 254, and the length of each nozzle array along the nozzle array direction 254 is typically on the order of 1 inch or less. Typical lengths of recording media are 6 inches for photographic prints (4 inches by 6 inches) or 11 inches for paper (8.5 by 11 inches). Thus, in order to print a full image, a number of swaths are successively printed while moving print cartridge 250 across the recording medium 20. Following the printing of a swath, the recording medium 20 is advanced along a media advance direction that is substantially parallel to nozzle array direction 254.

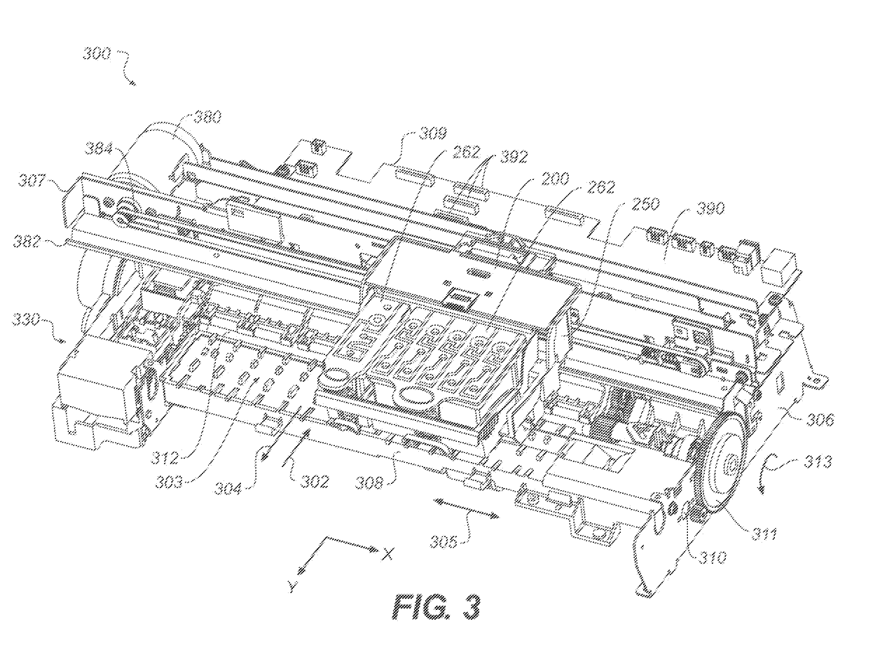

Also shown in FIG. 2 is a flex circuit 257 to which the printhead die 251 are electrically interconnected, for example, by wire bonding or TAB bonding. The interconnections are covered by an encapsulant 256 to protect them. Flex circuit 257 bends around the side of print cartridge 250 and connects to connector board 258 on rear wall 275. A lip 259 on rear wall 275 serves as a catch for latching print cartridge 250 into the carriage 200. When print cartridge 250 is mounted into the carriage 200 (see FIG. 3), connector board 258 is electrically connected to a connector on the carriage 200 so that electrical signals can be transmitted to the printhead die 251. Print cartridge 250 also includes two devices 266 mounted on rear wall 275. When print cartridge 250 is properly installed into the carriage of a carriage printer, electrical contacts 267 will make contact with an electrical connector on the carriage.

FIG. 3 shows a portion of a desktop carriage printer. Some of the parts of the printer have been hidden in the view shown in FIG. 3 so that other parts can be more clearly seen. Printer chassis 300 has a print region 303 across which carriage 200 is moved back and forth in carriage scan direction 305 between the right side 306 and the left side 307 of printer chassis 300, while drops are ejected from printhead die 251 (not shown in FIG. 3) on print cartridge 250 that is mounted on carriage 200. Carriage motor 380 moves belt 384 to move carriage 200 along carriage guide rail 382.

The mounting orientation of print cartridge 250 is rotated relative to the view in FIG. 2, so that the printhead die 251 are located at the bottom side of print cartridge 250, the droplets of ink being ejected downward onto the recording medium in print region 303 in the view of FIG. 3. Cyan, magenta, yellow and black ink sources 262 are integrated into print cartridge 250. Paper or other recording medium (sometimes generically referred to as paper or media herein) is loaded along paper load entry direction 302 toward the front of printer chassis 308.

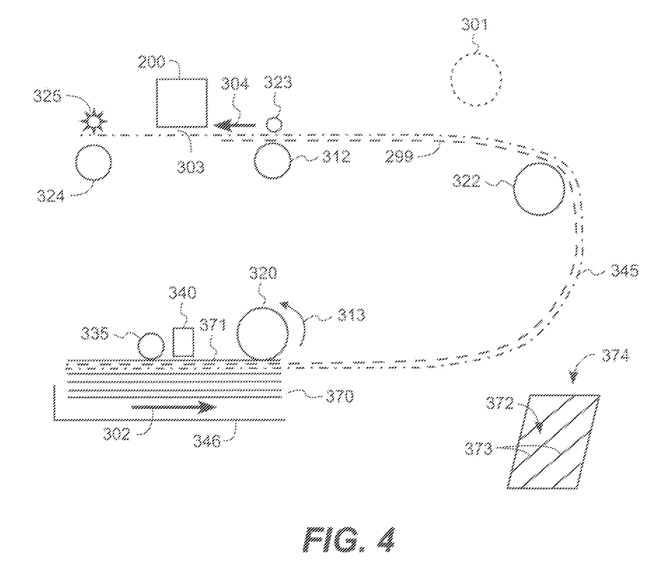

A variety of rollers are used to advance the medium through the paper transport path 345 (indicated by the dot dash lines) of the printer as shown schematically in the side view of FIG. 4. The paper transport path 345 is defined as the path the paper takes from its initial position in the media stack 370 to its printing position in the print region 303. In this example, a pick-up roller 320 moves the media 371, which is on top of a stack of paper 370 or other recording medium, in the direction of arrow, paper load entry direction 302. A turn roller 322 acts to move the paper around a C-shaped path (in cooperation with a curved rear wall surface) so that the paper continues to advance along media advance direction 304 from the rear 309 of the printer chassis (with reference also to FIG. 3). The paper is then moved by feed roller 312 and idler roller(s) 323 to advance across print region 303, and from there to a discharge roller 324 and star wheel(s) 325 so that printed paper exits along media advance direction 304. Feed roller 312 includes a feed roller shaft along its axis, and feed roller gear 311 (see FIG. 3) is mounted on the feed roller shaft. Feed roller 312 can include a separate roller mounted on the feed roller shaft, or can include a high friction coating on the feed roller shaft.

The motor that powers the paper advance rollers is not shown in FIG. 3, but the hole 310 at the printer chassis right-side 306 is where the motor gear (not shown) protrudes through in order to engage feed roller gear 311, as well as the gear for the discharge roller (not shown). For normal paper pick-up and feeding, it is desired that all rollers rotate in forward rotation direction 313. Toward the printer chassis left-side 307, in the example of FIG. 3, is the maintenance station 330.

Toward the printer chassis rear 309, in this example, there is located the electronics board 390, which includes cable connectors 392 for communicating via cables (not shown) to the printhead carriage 200 and from there to the print cartridge 250. Also on the electronics board are typically mounted motor controllers for the carriage motor 380 and for the paper advance motor, a processor and/or other control electronics (shown schematically as controller 14 and image processing unit 15 in FIG. 1) for controlling the printing process, and an optional connector for a cable to a host computer.

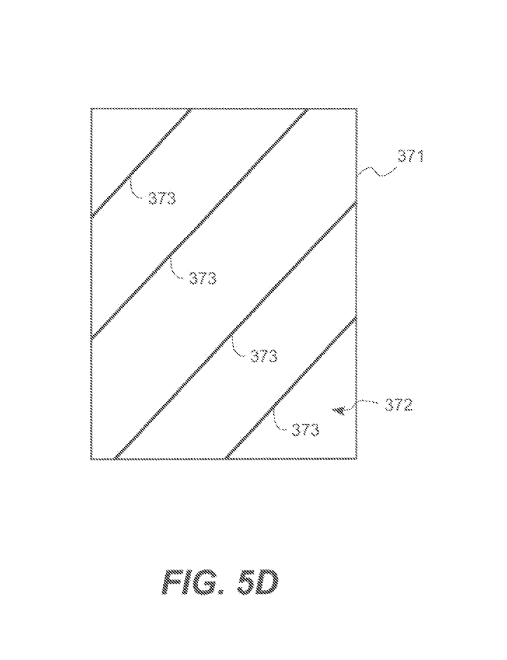

Referring to FIG. 4, an optical sensor 335, described in detail hereinbelow, provides two types of data. First, the optical sensor 335 provides motion data that is used to determine the amount of media 371 motion through a pre-print zone 299 of the paper transport path 345. Second, the optical sensor 335 detects the presence of the media identification markings 372 such as a barcode, on the non-print side 374 of the media 371 for determining the type of media being used. The barcode 372 typically includes a plurality of parallel lines 373 in a predetermined spaced-apart relationship so that each type of print media 371 has its own unique barcode 372. The imaging components (light source 315, lens 316, array sensor 317, see FIG. 6) of the optical sensor 335 are attached along the pre-print zone 299 of the printer in a stationary position and span over at least a portion of the media. Optionally, an identification mark reader 340, preferably a barcode sensor, reads media identification markings 372 instead of the optical sensor 335. This can be desirable, for example, when optimum performance for detection of media motion and identification marks requires operation at different wavelengths.

Ideally, the optional barcode sensor 340 is located at the same position, in the direction of media travel, as the optical sensor 335. In the direction perpendicular to media travel, the barcode sensor 340 should be located as close as possible to the imaging components of the optical sensor 335. This ensures that during the paper feed valid information from the optical sensor 335 and valid information from the barcode sensor 340 are available concurrently. The displacement perpendicular to media travel direction should be small enough to permit sensing motion of the smallest dimension paper for which the printer was intended. Frequently this minimum dimension is 4 inches. Depending on additional functionalities of the optical sensor 335, such as the detection of paper mis-feeds and skew, the optimum position can be further away from the barcode sensor 340.

Although the imaging components of the optical sensor 335 are illustrated having preferred positions, the imaging components of the optical sensor 335 may be placed anywhere suitable along the pre-print zone 299 of the paper transport path 345. The paper transport path is the path the media 371 takes for printing starting from its initial position in a paper tray 346 all the way to the print zone 303, and the pre-print zone 299 of the paper transport path is the path the media 371 takes for printing starting from the paper tray 346 all the way to the point before the media 371 enters the feed roller 312.

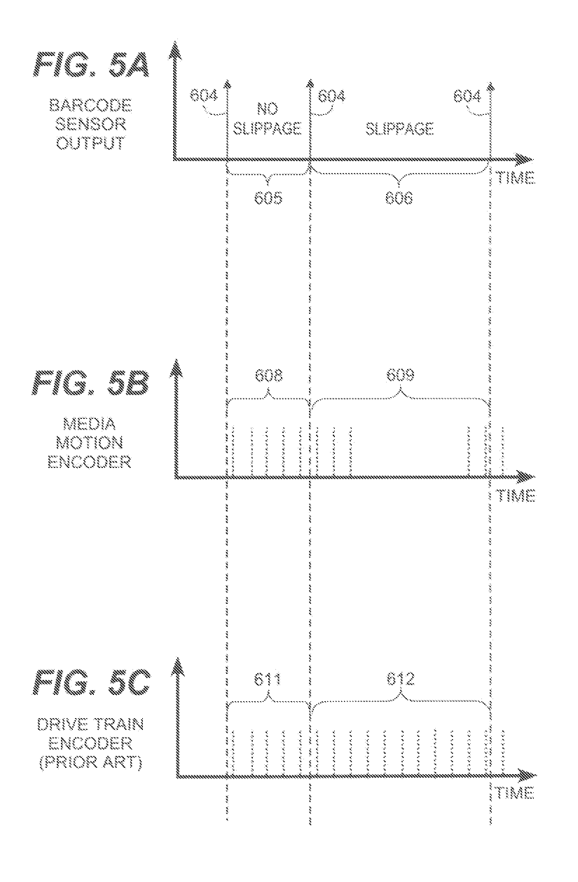

In FIG. 5D, the non-printing side 374 of sheet of media 371 is illustrated having evenly spaced media identification marks 372. In determining media ID marks 372, the detection of the media identification marks 372 can be performed by an optional barcode detector 340 or by the optical sensor 335. In the latter case, attenuation of the image brightness can be a suitable parameter for detecting the presence of media identification markings 372. FIG. 5a shows the output of the barcode sensor 340.

The presence of the media identification marks 372 is represented as signal lines 604. In this example, the media identification marks 372 are assumed to have an equal width. However, other embodiments can have media identification marks with a plurality of widths. The physical or spatial distance between media identification marks 372 is indicated by the number of encoder pulses (dotted line of FIGS. 5B and 5C) occurring between media identification marks. For example, when there is no media slippage, the time between signals 604 is represented as elapsed time 605, and when there is media slippage, the time between signals 604 is representative as elapsed time 606.

In the prior art drive system encoder 301 described above in the Background (FIG. 5C and 301 in FIG. 4), the number of signal counts 611 (representative of no media slippage) and the number of signal counts 612 (representative of media slippage) from the drive train encoder indicate relative incremental motion of the drive train. Drive train encoder pulses correctly indicate the distance in terms of encoder counts (611) when the media does not slip. In the case where the media slips with respect to the drive train encoder, a greater number of encoder counts occur (612) incorrectly indicating a greater separation between adjacent media marks.

FIG. 5B illustrates signals from the optical sensor 335 of the present invention. In this example, the optical sensor 335 transmits pulses whose frequency is proportional to the velocity of the media in the media advance direction 302. The signals (608 and 609) from the optical sensor 335 therefore indicate relative incremental amount of motion of the media 371. With the present invention, the signals 608 from the optical sensor 335 provide an accurate indication of the motion of the media 372 when slippage is not present as well as providing accurate signals 609 when slippage is present since the optical sensor 335 represents actual media motion, not drive train motion.

FIG. 6 illustrates the details of the optical sensor 335. In this regard, the optical sensor 335 includes a light source 315, which can be an LED or a laser diode, lens 316, array sensor 317 and image analysis electronics 318. The light source 315 directs light toward and onto the backside or non-print side of the media 371 for illuminating the non-print side 374 of the media 371. The reflected light is received by focusing optics, such as a lens 316, and an image is formed on the array (two-dimensional) sensor 317. In FIG. 6 the arrangement is such that the array sensor 317 captures light from diffuse reflectance as evidenced by the non-equal incidence angles of transmitted and reflected light. However, other embodiments can be used where the array sensor 317 captures light from specular reflection, i.e., when the angles of incidence is equal to the angle of reflected light. The array sensor 317 is connected to image analysis electronics 318 which determines the amount of motion of the print media 371 by comparing successive image data from the array sensor 317 that are captured at a constant rate. The capture rate must be sufficiently high so as to insure that some portion of the scene is included in each consecutive image pair captured; the required capture rate and the portion of the image repeated can be determined by those skilled in the art. The rate has to be high enough such that the media surface image is still partially contained in the subsequent image as can be determined by those skilled in the art. A one dimensional array sensor (also referred to as linear array sensor) can detect motion only in the direction of the imaging array. A two-dimensional array sensor can detect motion in two directions (X and Y). It can be positioned with respect to the paper transport path such that X coincides with the media advance direction and Y is perpendicular but still in the plane of the print media 317. Data corresponding to movement in the Y direction can be used to detect media skew. It is noted herein that the term “array sensor” refers to a one dimensional array sensor or a two-dimensional array sensor.

In determining motion of the print media 371, the data from the electronics can either be indicated by a series of pulses whose frequency is proportional to the media velocity (as shown in FIG. 5b), thereby simulating a conventional encoder wheel. Alternatively, the position information can be transmitted as digital data where the code value represents the amount of print media movement between two successive image captures such that the value 0 represents static (non-moving) media.

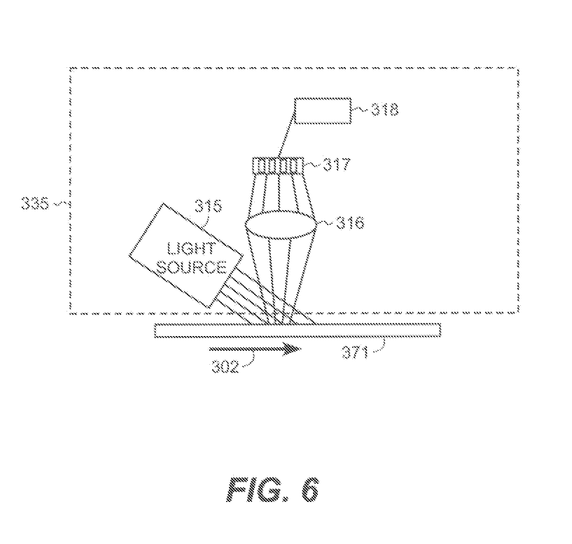

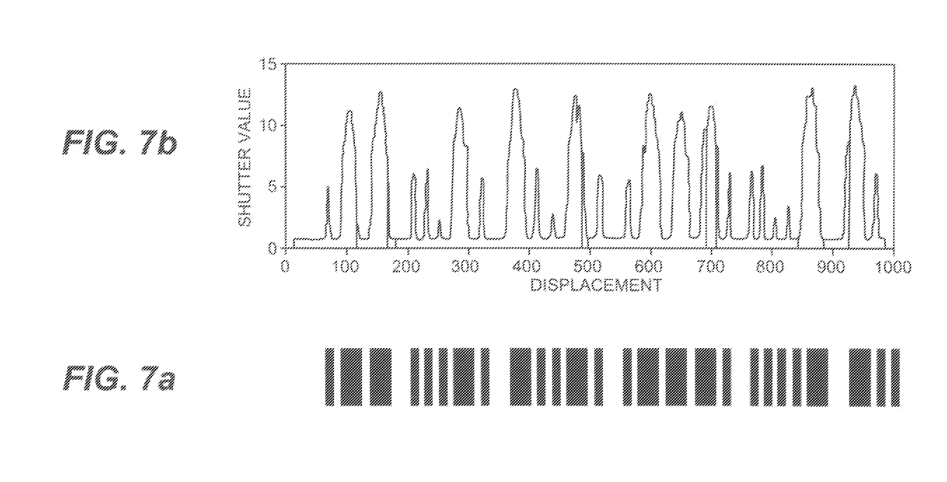

FIG. 7 illustrates an example of experimental data where the optical media motion encoder 335 provides functionality of the barcode sensor 340 or, in other words, provides media ID mark data. For this experiment, an optical mouse based on the sensor ADNS2051 (Avago industries) was used. The media motion signal is obtained by counting pulses from pins 2 and 3 (XA and XB quadrature pulses, respectively) of the ADNS2051. The reflectivity of the media surface is obtained by reading register values 0x0e and 0x0f (shutter lower and shutter upper) via the serial data port (pins 1 and 16) of the ADNS2051 chip. The quantity shutter value is defined as 256*shutter upper+shutter lower. It is plotted in FIG. 7b as a function of media displacement. FIG. 7a is a representation of the actual barcode imprinted on the media. A comparison shows that a higher shutter value corresponds to a dark bar whereas a lower shutter value corresponds to a light bar, this illustrating the ability to obtain both displacement and reflectivity information from 335.

The invention has been described in detail with particular reference to certain preferred embodiments thereof, but it will be understood that variations and modifications can be effected within the spirit and scope of the invention.

### PARTS LIST

10 Inkjet printer system
12 Image data source
14 Controller
15 Image processing unit
16 Electrical pulse source
18 First ink source
19 Second ink source
20 Recording medium
100 Inkjet printhead
110 Inkjet printhead die
111 Substrate
120 First nozzle array
121 Nozzle(s)
122 Ink delivery pathway (for first nozzle array)
130 Second nozzle array
131 Nozzle(s)
132 Ink delivery pathway (for second nozzle array)
181 Droplet(s) (ejected from first nozzle array)
182 Droplet(s) (ejected from second nozzle array)
200 Carriage
250 Print cartridge
251 Printhead die
253 Nozzle array
254 Nozzle array direction
255 Mounting substrate
256 Encapsulant
257 Flex circuit
258 Connector board
259 Lip
262 Ink sources
266 Device
267 Electrical contact
275 Rear Wall
299 Pre-Print Zone
300 Printer chassis
301 Drive system encoder
302 Paper load entry direction
303 Print region
304 Media advance direction
305 Carriage scan direction
306 Right side of printer chassis
307 Left side of printer chassis
308 Front of printer chassis
309 Rear of printer chassis
310 Hole (for paper advance motor drive gear)
311 Feed roller gear
312 Feed roller
313 Forward rotation direction (of feed roller)
315 Light Source
316 Lens
317 Sensor
318 Image analysis electronics
320 Pick-up roller
322 Turn roller
323 Idler roller
324 Discharge roller
325 Star wheel(s)
330 Maintenance station
335 Optical sensor
340 Barcode sensor
345 Paper transport path
346 Paper tray
370 Stack of media
371 Top piece of medium
372 Barcode
373 Barcode lines
374 Non-print side of media
380 Carriage motor
382 Carriage guide rail
384 Belt
390 Printer electronics board
392 Cable connectors
604 Signal lines
605 Elapsed time
606 Elapsed time
608 Signals
609 Signals
611 Signal counts
612 Signal counts

1. An inkjet printer comprising:
(a) a paper tray for holding print media;
(b) a pick-up roller for moving the print media along at least a portion of a pre-print zone of a paper transport path;
(c) a light source disposed along the pre-print zone of the paper transport path that directs light toward a non-print side of the print media for illuminating the non-print side of the print media;
(d) an array sensor that receives reflected light from the non-print side of the print media; and
(e) image analysis electronics that receives data from the array sensor and uses the data from the sensor to determine an amount of motion of the print media in the pre-print zone.

2. The inkjet printer as in claim 1, wherein the non-print side of the print media is positioned in the paper tray so that the non-print side of the print media reflects the light from the light source.

3. The inkjet printer as in claim 2, wherein the light source, array sensor and image analysis electronics further function to sense media Markings on the non-print side of the print media while the media is moving through the pre-print zone.

4. The inkjet printer as in claim 3, wherein the media markings are barcodes.

5. The inkjet printer as in claim 1, wherein the array sensor is a two-dimensional array sensor.

6. The inkjet printer as in claim 5, wherein the light source, array sensor and image analysis electronics senses skew.

7. The inkjet printer as in claim 2 further comprising a barcode sensor that functions to sense media markings on the non-print side of the print media while the media is moving through the pre-print zone.

8. The inkjet printer as in claim 7, wherein the media markings are barcodes.

9. The inkjet printer as in claim 7, wherein the array sensor is a two-dimensional array sensor.

10. The inkjet printer as in claim 7, wherein the light source, array sensor and image analysis electronics senses skew.
